(19) United States
(12) Patent Application Publication
(10) Pub. No.: US 2015/0262151 A1
(43) Pub. Date: Sep. 17, 2015

(54) Access Control System for Online Content

(71) Applicant: Nibl, Inc., Austin, TX (US)

(72) Inventors: Joseph R. Enzminger, Austin, TX (US); Jefferson C. Lind, Austin, TX (US)

(21) Appl. No.: 14/645,154

(22) Filed: Mar. 11, 2015

Related U.S. Application Data
(60) Provisional application No. 61/951,267, filed on Mar. 11, 2014.

(51) Int. Cl. G06Q 20/12; G06Q 30/06

(52) U.S. Cl. CPC G06Q 20/127; G06Q 30/06

(57) ABSTRACT

Methods and systems allow an online content publisher to set prices for access to its online content, set access terms for that online content, and obtain compensation for consumer access to that online content. An online content publisher may set prices and access terms on a link-by-link basis directly from the online content publisher's own web page. Online content access is accomplished through a purchasing interface which is consistent from one online content publisher page to the next and which appears directly on the web page containing the link to the online content to which access is desired.

### CROSS-REFERENCE TO RELATED APPLICATION

The Applicant claims the benefit, under 35 U.S.C. §119(e), of U.S. Provisional Patent Application No. 61/951,267 filed Mar. 11, 2014, and entitled “Access Control System for Online Content.” The entire content of this provisional application is incorporated herein by this reference.

### TECHNICAL FIELD OF THE INVENTION

The invention is directed to systems which allow convenient and secure access control for online content, particularly, content accessible via the Internet. Although not limited to applications involving payment for granting access to online content, embodiments of the invention are particularly suited to such applications. The invention encompasses methods for facilitating access control for online content as well as computer systems and program products for implementing such methods.

### BACKGROUND OF THE INVENTION

The Internet provides a very convenient platform for publishing digital media such as music, photographs, literary works, video and audio visual works, reports, blogs, articles, and many other types of digitally stored products and material (all generally referred to herein as “content”). However, content publishers have found it difficult to obtain compensation for their Internet-published content. For content that can command relatively high prices, such as subscriptions to entire news websites, magazine or journal websites, or website accessible databases, it is economically viable for the publishers to sell subscriptions through their own or third-party administered online payment systems. In return for the subscription payment by credit card or electronic funds transfer, the purchaser is provided an account with a user identifier and password which the purchaser may then use to obtain access to the online material. However, even with these online payment systems, internal costs or external transactions fees effectively reduce the compensation to the online publisher. Also, internal costs of running an online payment system and/or transaction fees associated with third party payment systems make these systems too expensive for online publishers providing online content that cannot command a relatively high price. For example, a blogger may wish to sell online access to their blog for a relatively low price, say in the neighborhood of one dollar or less. The costs associated with prior online payment systems may take the majority of that overall sales price, leaving the blogger with little compensation for their efforts. The problem is exacerbated for online publishers who may wish to provide access to their online publications on a limited basis. For example, an electronic magazine or news publisher may wish to provide access to individual articles at very low prices rather than requiring an expensive subscription for access to the entire publication. Again, prior online payment systems make such pay-per-access models economically unviable. Ultimately, the lack of a viable way for an online content publisher to obtain compensation for their content leaves the content publisher little choice but to publish their content online for free and seek other compensation models such as models which rely on advertising revenue. The only other alternative would be to simply not publish their content online

### SUMMARY OF THE INVENTION

The present invention is directed to methods and systems for allowing an online content publisher to set prices for access to their online content, set access terms for that online content, and obtain compensation for consumer access to that online content. Methods and systems embodying the principles of the invention facilitate low transaction costs and thus allow online content publishers to set very low prices for access to online content and still obtain fair compensation for granting access to that online content. In some embodiments, the invention allows an online content publisher to set their prices and access terms on a link-by-link basis directly from the online content publisher's own web page. From the online content consumer's standpoint, methods and systems according to the present invention allow the purchase of online content access quickly and simply through a purchasing interface which is consistent from one online content publisher page to the next and which appears directly on the web page containing the link to the online content to which access is desired. Because embodiments of the invention may be embodied in systems containing various computer processing devices, the invention also encompasses program products storing program code which is executable to perform the various method steps.

Throughout this disclosure and in the claims, the following definitions will apply unless specifically stated otherwise. “Premium content” refers to any content to which a publisher may restrict access. Access to premium content may or may not be conditioned on a payment to obtain access. “Online” refers to availability or accessibility across a network such as the Internet, which provides a standard for communications between different network accessible devices. Although the invention is particularly suited for applications in which the network used for communications is the Internet, the invention may be applied to any network such as private networks or intranets employing any suitable network infrastructure. “Web page” refers to a network address which stores information which can be executed by suitable software such as Internet browser software to display information and to provide links to premium and other content. A “link” is a functional network address such as an Internet hyperlink which may be invoked to direct suitable network access software such as an Internet browser to a web page. A “widget” is an auxiliary software application that can be installed and executed within a web page.

One aspect of the present invention provides a method for controlling access to online content. In particular, the method puts a web page containing a link to premium content in a condition in which a user may request and gain access to the premium content. In one embodiment a method for controlling access to online content includes receiving a gateway page setup request at an access server. The gateway page setup request is received across a computer network such as the Internet from a consumer access device such as a personal computer running Internet browser software, and is associated with a web page address for a content gateway web page. This content gateway web page comprises a web page which includes one or more links to premium content, access to which is controlled through the method. Responsive to the gateway page setup request the access server in this embodiment of the invention searches an asset record database for an asset record associated with a respective link provided on the content gateway web page. This search is performed for each different premium content link provided on the content gate. Upon locating the respective asset record associated with a respective premium content link, the access server generates a descriptor for that link and causes the descriptor to be communicated to the consumer access device across the computer network. Each descriptor includes at least an indication that content associated with the respective link is premium content, and may include additional information such as the terms of access to that premium content such as price and time limits for access included in the asset record. The method performed through the access server according to this example embodiment then includes receiving back from the consumer access device a respective access widget request for each descriptor sent to the consumer access device. Responsive to each access widget request, the access server causes a respective access widget to be communicated to the consumer access device over the computer network. Each access widget is executable at the consumer access device to produce a first consumer interface that allows a consumer at the consumer access device to cause the generation of a content access signal indicating an intention to access the content associated with the respective premium content link.

Further method steps may be performed at the access server to actually grant access to the premium content. In one embodiment these further steps include receiving the content access signal at the access server. The content access signal is received from the consumer access device across the computer network and identifies the link to the content to which access is desired. Responsive to receipt of the content access signal, the access server determines if conditions are met for access to the respective content associated with the link identified by the content access signal. If conditions for access are met, the access server generates a ticket record including a unique ticket record identifier and content identifying information, stores the ticket record in an access database, generates a ticket corresponding to the ticket record, and causes the ticket to be communicated to the consumer access device over the computer network. The access control process performed at the access server next includes receiving a redemption request. The redemption request is received over the computer network from a content server hosting the content associated with the link identified by the content access signal, and includes the first ticket. Responsive to receipt of the redemption request, the access server uses the ticket to look up the first ticket record and verifies that the first ticket record is associated with the content associated with the link identified by the content access signal. If this verification is successfully completed, the access server modifies its state based upon the conditions for access to the content associated with the link and causes an access approval signal to be communicated to the content server over the computer network. If the conditions for access require a payment from the consumer, the change in state includes debiting the consumers account with the access server and crediting the content publisher's account.

It will be appreciated that the process steps described above are process steps performed by the access server and are depend upon actions taken at the consumer access device and at the content server hosting the premium content. These actions external to the access server will be described in the Description of Illustrative Embodiments below in connection with the drawings.

Another aspect of the invention involves methods performed at the access server to allow a publisher of online content to set up their own web page as a content gateway web page to facilitate the content access processes according to the invention. One embodiment of this aspect of the present invention includes receiving a publisher page administration request at the access server. The publisher page administration request is received from a publisher administration device such as a personal computer running an Internet browser, and identifies a web page to be administered, that is, a web page which is to serve as a content gateway web page. Responsive to the receipt of the publisher page administration request, the access server causes an administration widget to be communicated to the publisher administration device, the administration widget being executable at the publisher administration device to display an administration interface on the web page to be administered. The administration interface allows the publisher to make other selections which ultimately generate a link setup request identifying a particular premium content link on the web page to be administered together and publisher-selected conditions for access to the premium content through the link, and causes that request to be communicated to the access server over the computer network. The method executed at the access server then includes receiving the link setup request at the access server. Responsive to the link setup request, the access server generates and stores an asset record at an asset record database accessible to the access server. This asset record includes data specifying the publisher-selected conditions for access to the premium content through the link and as noted above, is used to produce the descriptors used in setting up a content gateway web page to generate access signals.

The present invention also encompasses an access server for administering access control for online content, and for enabling remote configuration of a web page as a content gateway web page. In this aspect of the invention the access server includes a network controller operatively connected to a computer network, one or more processors operatively connected for communications to and from the computer network through the network controller, and one or more program storage devices storing program code executable to perform the access server steps described above, described further below in connection with the drawings, and set out in the claims.

Since embodiments of the present invention may be implemented in general purpose data processing systems, the present invention encompasses program products comprising non-transitory computer readable media storing program code. The program code may include gateway page setup program code and access widget distribution program code. The gateway page setup program code is executable at the access server to cause the server to receive the gateway page setup request and respond to that request as described above and further below. The access widget distribution program code is executable by the access server to cause the access server to receive the access widget request respond to that request as described above and further below. Program products according to the invention may also store content access signal processing program code and redemption signal processing program code. The content access signal processing program code is executable by the access server to cause the access server to receive a content access signal and respond to such a signal as described above and further below. The redemption signal processing program code is executable by the access server to cause the access server to receive a redemption request and respond to the redemption request as described above and further below.

Other program products according to the invention may store program code executable to facilitate the setup of a content gateway web page as described above. These program products may include publisher page administration program code and publisher link setup program code. The publisher page setup program code is executable to cause the access server to receive a publisher page administration request and respond to such a request as described above and further below. The publisher link setup program code is executable to cause the access server to receive a link setup request and respond to such a request as described above and further below.

These and other advantages and features of the invention will be apparent from the following description of illustrative embodiments, considered along with the accompanying drawings.

### BRIEF DESCRIPTION OF THE DRAWINGS

FIG. 1 is a diagrammatic representation of a network through which various embodiments of the invention may be implemented.

FIG. 2 is a diagrammatic representation of a server or access device which may be employed according to the invention.

FIG. 3A is a flow chart showing a first portion of an overall process in which a consumer of online content may obtain access to premium content according to various embodiments of the invention.

FIG. 3B is a flow chart showing a second portion of an overall process in which a consumer of online content may obtain access to premium content according to various embodiments of the invention.

FIG. 3C is a flow chart showing a third portion of an overall process in which a consumer of online content may obtain access to premium content according to various embodiments of the invention.

FIG. 4 is a diagram showing communications between a consumer access device, a content access host/premium content host, and an access server according to one implementation of the invention.

FIG. 5A is a flow chart showing a first portion of an overall process in which an online content publisher may assign access terms to online content according to various embodiments of the invention.

FIG. 5B is a flow chart showing a second portion of an overall process in which an online content publisher may assign access terms to online content according to various embodiments of the invention.

FIG. 6 is a diagram showing communications between a publisher administration device, a content gateway page server, and an access server according to various embodiments of the present invention.

FIG. 7 is a diagram showing further communications between a publisher administration device, a content gateway page server, and an access server according to various embodiments of the present invention.

FIG. 8 is a screen shot of a web page showing an expanded consumer/user control panel according to one embodiment of the present invention.

FIG. 9 is a screen shot of a web page showing the consumer/user control panel in a collapsed state according to an embodiment of the invention.

FIG. 10 is a screen shot of a web page which is set up as a content gateway web page and showing an owner control panel according to one form of the present invention.

FIG. 11 is a screen shot of a web page showing the owner control panel in a collapsed state according to one form of the invention.

FIG. 12 is a screen shot of on a hosted web page which has been set up as a content gateway web page and showing a consumer/user control panel in a collapsed state.

### DESCRIPTION OF ILLUSTRATIVE EMBODIMENTS

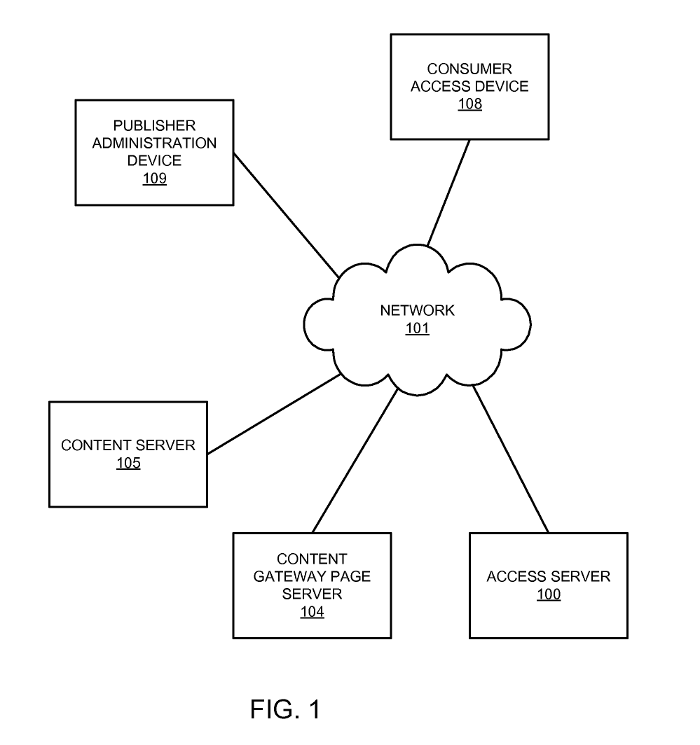

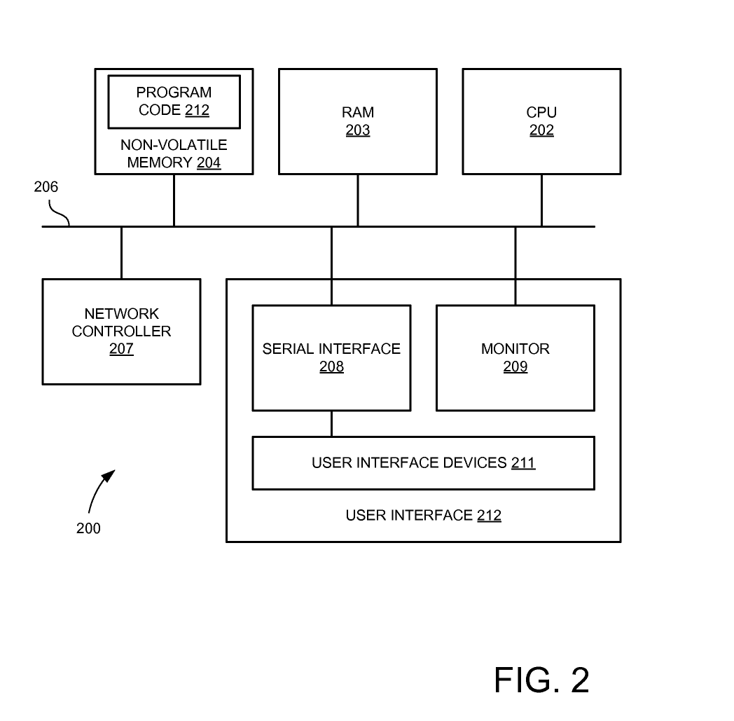

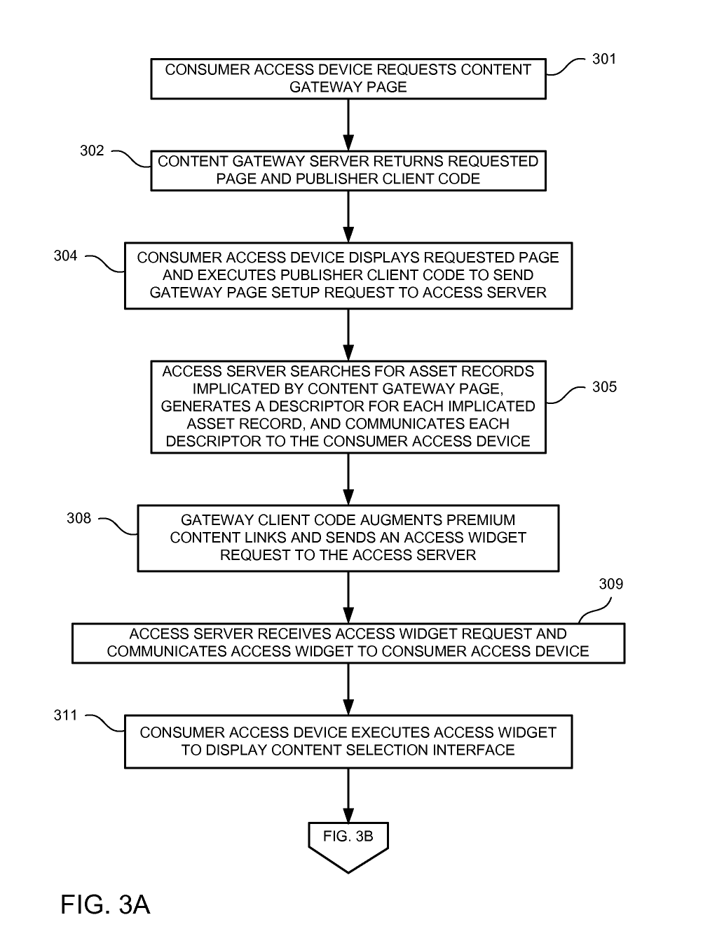

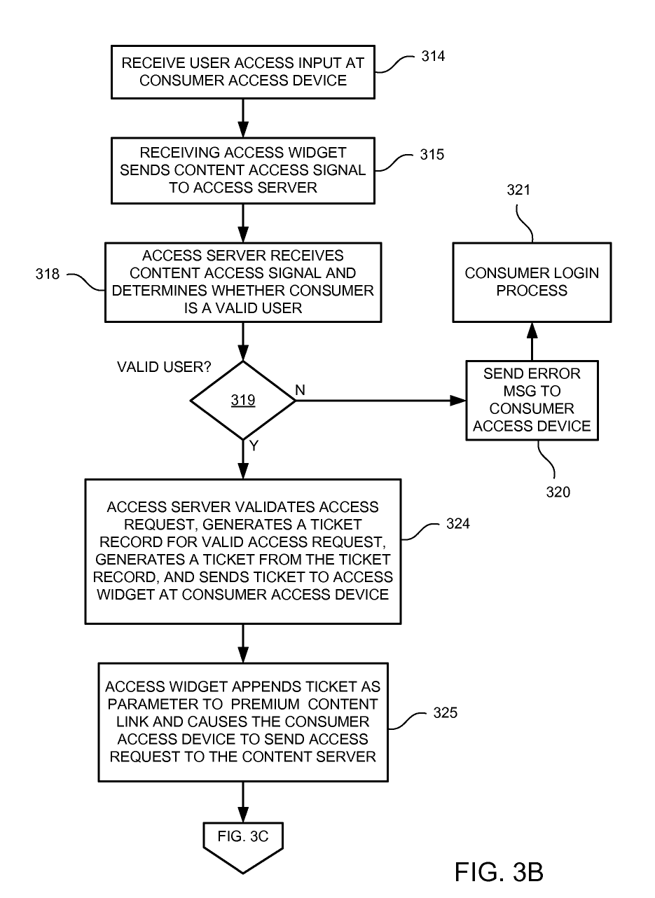

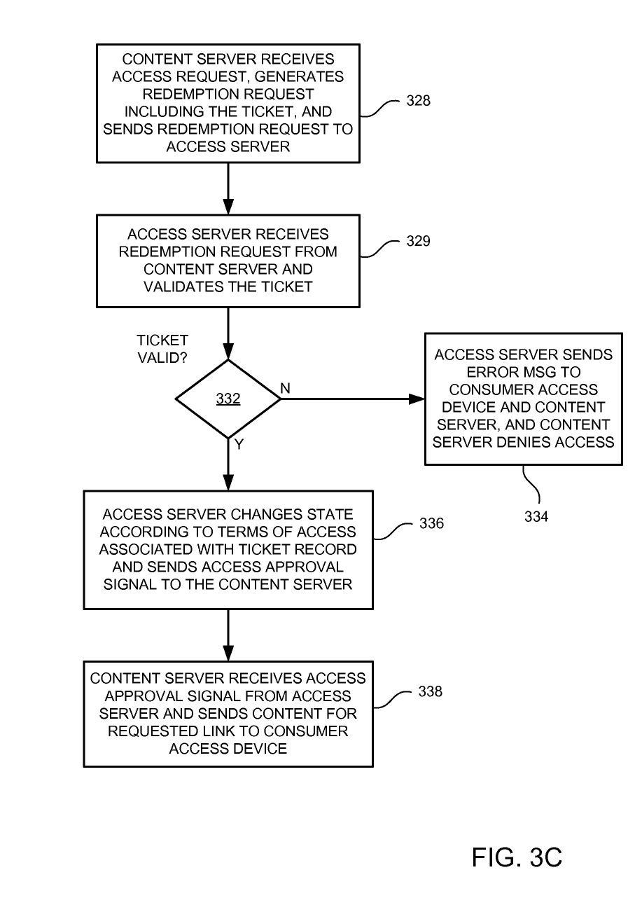

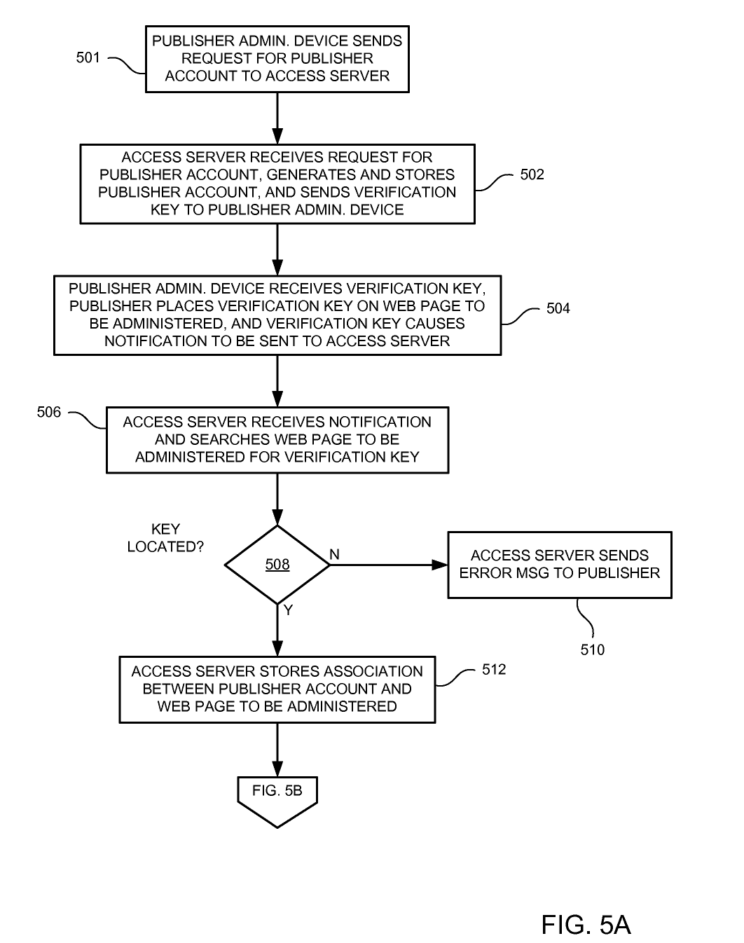

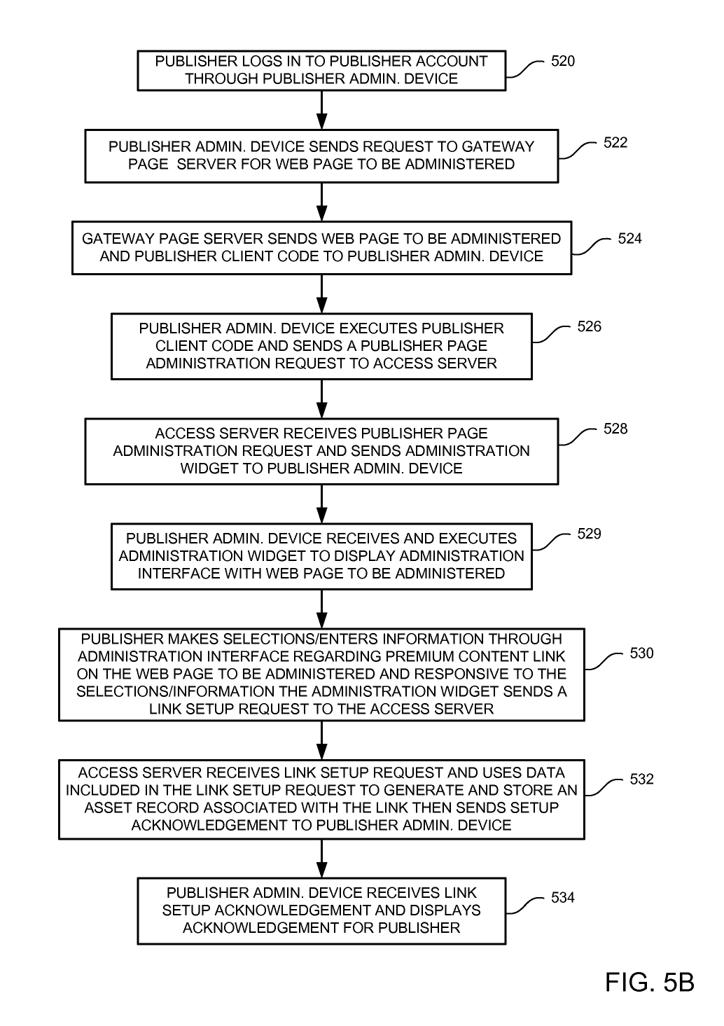

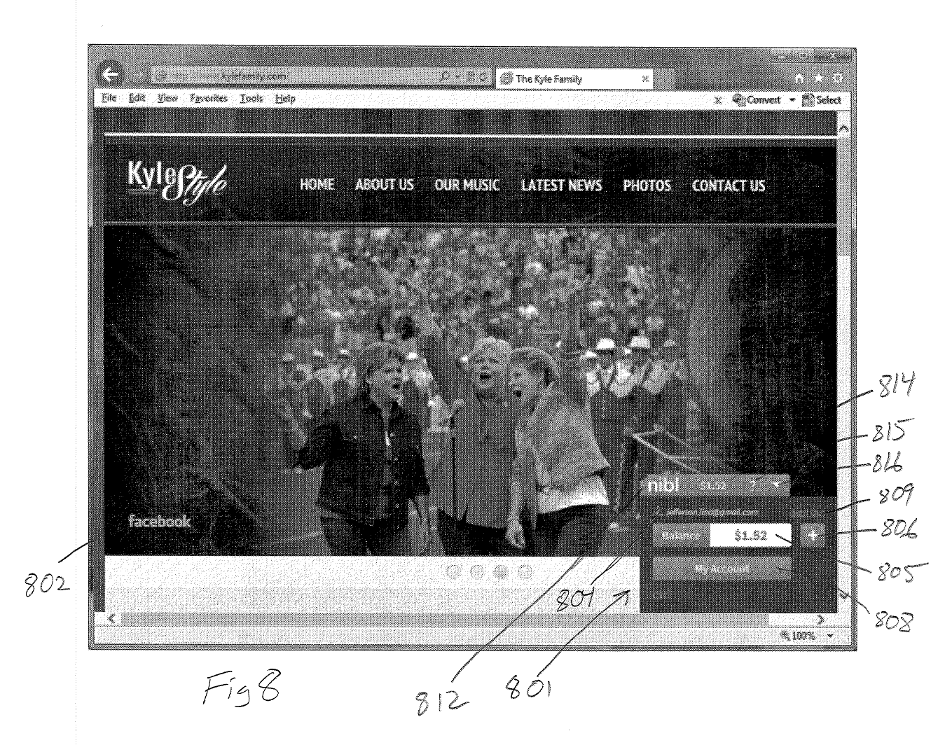

In the following descriptions, FIGS. 1 and 2 will be used to describe a network and network devices which may be included in various embodiments of the present invention. FIGS. 3A-C and 4 will be used to describe an overall process of providing access control according to embodiments of the present invention. FIGS. 5A-B, 6 and 7 will be used to describe an overall process of facilitating publisher page configuration according to the present invention. FIGS. 8 12 will then be used to illustrate certain user interfaces employed in certain forms of the invention.

Referring to FIG. 1, the present invention is implemented by an access server 100 connected for communications in a computer network 101. Access server 100 comprises a data processing system made up of one or more separate computers which receives signals or communications from and sends communications to the other devices connected for communications to the network. The network may be the Internet for example, or any other type of private or public network that facilitates communications between different network connected devices.

The other types of devices connected to network 101 in FIG. 1 are either servers or access devices. The servers store web pages and content which are accessible by the access devices under the communications standard of the network. Content gateway page server 104 stores in its associated memory or data storage devices premium content and other content accessible to the other devices across the network in accordance with methods according to the present invention. In particular, each of the unlimited number of content gateway page servers 104 that may be connected to the network 101 stores at least one content gateway web page that includes at least one link to premium content. Each content server 105 stores premium content addressed by a premium content link, and may store other network accessible content as well. It should be appreciated that a single device may be both a content gateway page server 104 and a content server 105 within the scope of the present invention. That is, a content gateway web page may include a premium content link which addresses content on another server (that is, a content server 105), and/or may include a premium content link which address content that is stored locally at the content gateway page server 104 which stores the respective content gateway page. Each of the servers, 100, 104, and 105 shown for purposes of example in FIG. 1 will execute suitable software to allow the device to function as a server under the particular communications standards and techniques of network 101.

Access devices included in the example network shown in FIG. 1 are devices that execute program code that allows the devices to access web pages and content stored by the content gateway page servers 104 and content servers 105 which are authorized for access in accordance with the present invention and in accordance with other access limitations which may be present in the system. Consumer access device 108 may comprise a personal computer, laptop computer, notebook computer, tablet computer, or smart phone executing either a general purpose browser for accessing web pages addressable through the network 101, or specialized browser software. In particular, consumer access device 106 may allow a consumer to access content gateway web pages and obtain access to premium content as described herein. Publisher administration device 109 is also an access device such as a personal computer, laptop computer, notebook computer, tablet computer, or smart phone executing either a general purpose browser for accessing web pages addressable through the network 101. However, publisher administration device 109 is used by a publisher to set up their content gateway web pages for controlled access to premium content accessible through the content gateway web pages. It will be appreciated that the same device executing the same browser software may function both as a consumer access device 108 and a publisher administration device 109 within the scope if the present invention.

Network communications between the various devices may be in any standard and may be provided via any suitable transmission technique or combination of transmission techniques. At least part of the transmission path between devices may be wireless. Any wired portions of the transmission path between devices may be over an electrical conductor or an optical fiber, or any combination of such transmission lines.

FIG. 2 shows a logical and hardware block diagram 200 of a server such as the access server 100 shown in FIG. 1 or an access device such as the publisher administration device 109 or the consumer access device 108 shown in FIG. 1. Although the respective device may take any one of a number of different forms depending upon its processing requirements, each server or access device may include the general arrangement of components shown in FIG. 2. For example, a consumer or publisher administration device may comprise any data processing system capable of executing an Internet browser where the network over which communications are supported is the Internet. Such devices include personal computers, laptop computers, notebook computers, tablet computers, and smart phones. Servers within the scope of the present invention will generally include processing systems having relatively higher processing capacity and speed, relatively higher data storage capacity, and redundancies to ensure continuous operation.

Referring to FIG. 2, an access device or server generally includes a central processing unit (CPU) 202 (or perhaps multiple CPUs) along with random access memory (RAM) 203 and a non-volatile data storage device 204. All of these devices are connected on a system bus 206 with a network controller 207, a serial interface 208, and a monitor 209. The monitor 209, together with various user interface devices 211 shown connected through serial interface 208, represent a user interface 212 for the respective device or server.

Those familiar with data processing devices and systems will appreciate that other basic electronic components may be included in server or access device employed according to the present invention such as a power supply, cooling systems for the various system components, and other devices that are common in server computers, personal computers, laptop computers, notebook computers, tablet computers, and smart phones. These additional devices are omitted from the drawings so as not to obscure the present invention in unnecessary detail.

System bus 206 is shown in FIG. 2 merely to indicate that the various components are connected in some fashion for communication with CPU 202 and is not intended to limit the invention to any particular bus architecture. Numerous other variations in the access device or server may be used without departing from the principles of the present invention. For example, some personal computers may include a graphics processor separate from the CPU which provides a suitable driving signal for driving monitor 209. Non-volatile storage device 204 in the instance of a server may include an array of individual data storage devices to implement a RAID system. Also, in the case of a server within the scope of the present invention, a user interface may be implemented through a separate data processing device connected on a network with the server. At least some of the user interface functionality in this case would be provided through signals communicated through network controller 207 or through some other input/output controller included in the particular system. It should also be appreciated that, particularly in the case of the access server shown in FIG. 1, the various functions performed by the server may be distributed across a number of different data processing devices, each including a separate data processing system such as that shown in with FIG. 2, provided that some separate processing systems may not include a directly connected user interface 212 as shown in FIG. 2. For example, database services employed by access server 100 may be provided through a separate data process system 200 dedicated for maintaining and providing access to the asset record database and ticket record database described further below, and other databases employed to provide the desired content access control and/or content access control administration according to the present invention.

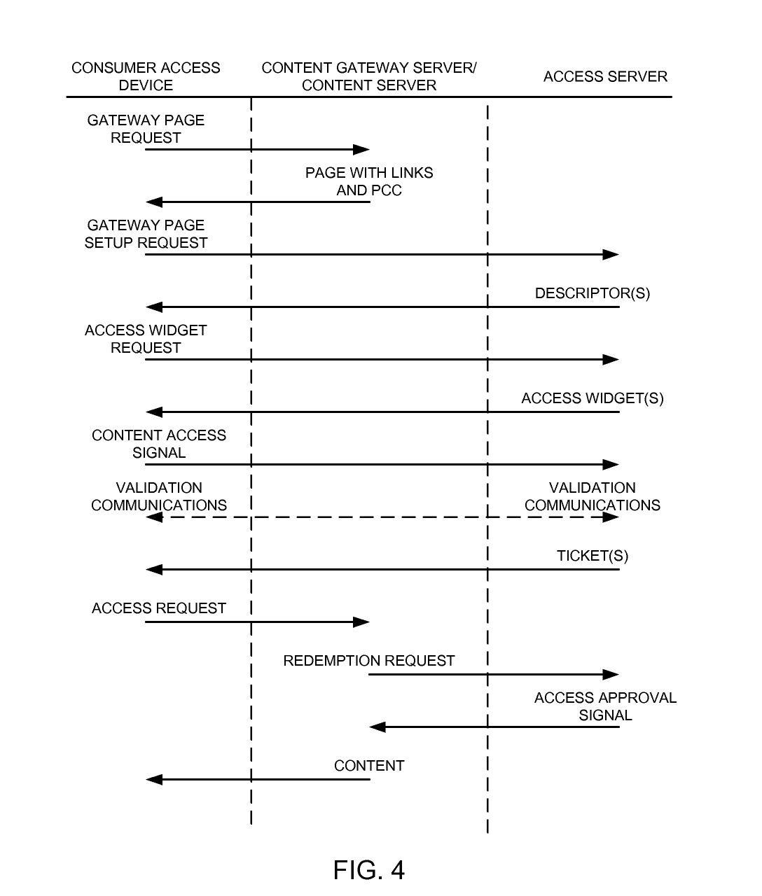

In the illustrated data processing system 200, CPU 202 executes software, that is, program code 212, which ultimately controls the entire system including the receipt and transmission of various communications. These communications will be described below particularly in connection with the diagrams shown in FIGS. 4, 6, and 7. In the case of the access server 100, CPU 202 or a CPU in an associated data processing system to which access server functions are distributed may execute the gateway setup program code, access widget distribution program code, content access signal processing program code, redemption signal processing program code, publisher page administration program code, and publisher link setup program code. In the case of the access devices 108 and 109 shown in FIG. 1, the program code 212 executed by the respective CPU associated with that device may execute Internet browser software where network 101 comprises the Internet. These access devices may also execute the widgets and publisher client code described herein.

It should be noted that the invention is not limited to data processing devices employing the personal computer-type arrangement of processing devices and interfaces shown in example system 200. Other data processing systems through which the invention may be implemented may include one or more special purpose processing devices to perform the various processing steps for implementing the invention. Unlike general purpose processing devices such as CPU 202, which may comprise an Intel Core® processor for example, these special purpose processing devices may not employ operational program code to direct the various processing steps.

An overall content access control process may be described with reference to the flow charts of FIGS. 3A-C. The process steps shown in FIG. 3A are process steps performed to set up a content gateway web page to allow a system user to gain access to premium content according to some embodiments of the invention. FIGS. 3B and 3C show process steps performed in some embodiments to allow a user to submit a request for access to premium content and obtain such access.

As shown at block 301 in FIG. 3A a user or consumer at a consumer access device such as 108 in FIG. 1 operates the device so that it communicates a request for a web page, particularly a content gateway web page to the computer network. This user operation may comprise simply an input through a browser executing at the access device to request a web page comprising a content gateway web page. In response to the request communicated over the network, and as shown at process block 302 in FIG. 3A, the content gateway page server hosting that content gateway web page communicates the requested web page back to the requesting consumer access device across the network, including one or more links to premium content (files, html pages, music, video, actions), and also including publisher client code included with or associated with the requested webpage.

Upon receipt from the content gateway page server, the consumer access device (108 in FIG. 1), and particularly the browser executing at that device displays the content gateway web page on a monitor (e.g. monitor 209 in FIG. 2) associated with the consumer access device and executes the publisher client code as shown at process block 304. The publisher client code causes the consumer access device to generate and send a gateway page setup request to the access server (100 in FIG. 1). The gateway page setup request effectively requests information about each to premium content on the content gateway web page. In some forms of the present invention, the gateway page setup request may include information (such as a user login cookie) that allows the access server to determine the user/consumer that is currently visiting the content gateway web page.

Responsive to the gateway page setup request, the access server searches and asset record database for a respective asset record associated with each premium content link. As indicated at process block 305, the access server also uses the respective asset record it locates to generate a respective descriptor for that asset record and the corresponding premium content link on the content gateway web page. As also shown at process block 305, the access server then causes the descriptor for each premium content link to be communicated to the consumer access device. Each descriptor may be signed by the access server with a secret key specific to the domain of the premium content link. The signature allows the access server later in the process to ensure that the given descriptor has not been altered. Each returned descriptor contains at least information indicating that the content associated with the premium content link is in fact premium content. In some forms of the invention, each descriptor may include further information about the respective premium content link such as whether or not the user/consumer associated with the gateway page setup request is allowed to access the link, how much access costs, the term (time limit if any) of access, and other information obtained from the corresponding asset record.

As indicated at process block 308 in FIG. 3A, the publisher client code executing at the content gateway web page displayed at the consumer access device augments the premium content links This augmentation may include replacing or annotating the respective premium content link with the information contained in the respective descriptor returned for that link. The annotation may be implemented as an embedded frame (IFRAME) that requests an access widget from the access server using information in the respective descriptor. Thus process block 308 also shows that the consumer access device communicates an access widget request to the access server. The access widget request may include a separate request for each premium content link appearing on the content gateway web page, because the system may employ different access widgets for different types of premium content.

As shown at process block 309 in FIG. 3A, the access server receives the access widget requests, and, responsive to each such request, causes the appropriate access widget to by communicated to the consumer access device across the network. Each access widget includes user interface elements (content selection interface) that allow the consumer/user to indicate an intention to purchase the content associated with the respective premium content link. As shown at process block 311 in FIG. 3A, the consumer access device executes the access widgets to display the corresponding content selection interface.

Referring now to FIG. 3B the overall process includes receiving a user access input at the consumer access device as shown at process block 314. This user access input is an input through the content selection interface provided by one of the access widgets executed at the consumer access device. As shown at process block 315 in FIG. 3B, the respective access widget which received the user access input causes the consumer access device to communicate a content access signal to the access server. The access signal may include the descriptor associated with the respective premium content link and information about the consumer/user (if consumer/user information is available at this point in the process).

In response to the content signal access signal, the access server in this example process performs a number of operations that ultimately determine conditions are met for access to the content associated with the premium content link. As shown at process block 318, the access server determines whether the consumer/user is a valid user of the content access control system. This may include checking for a login cookie included in the content access signal to determine if the consumer/user is logged in to the content access control system. Regardless of the particular steps performed at process block 318, if the consumer/user is not a valid user, the process branches from decision box 319 and the access server sends an error message to the consumer access device as shown at process block 320. This error message may indicate that the consumer/user log in to the content access control system in accordance with a suitable login process as indicated at process block 321. The error message may include a user interface that allows the consumer/user to log in.

If the consumer/user is valid as indicated by a positive result at box 319, the process proceeds to process block 324 where the access server validates the access request represented by the access signal received at process block 318. This validation may include validating the descriptor or information from the descriptor included in the access signal and may include verifying the signature associated with the descriptor. If the descriptor/descriptor information/access request is valid, the access server may also validate that the user has sufficient funds in their respective consumer/user account with the access control system to cover any purchase price associated with the content corresponding to the premium content link. If a purchase price is required and if the consumer/user account does not contain sufficient funds, the access server causes an error message to be communicated to the consumer access device. The error message may be communicated with a widget which causes the consumer access device to generate a user interface that requests that the consumer/user add funds to their account. If all necessary conditions are met, the access server generates a ticket record as indicated at process block 324. The ticket record contains information specific to the access request, such as, for example, a subset of information in the corresponding to the respective premium content link, information about the consumer/user, an expiration date and/or time for the ticket record, and a unique ticket record identifier. The access server stores the ticket record in a ticket record database maintained by the access server, and generates a ticket for the ticket record using the unique identifier of the ticket record. In some cases, the access server may sign and encrypt the ticket. Ultimately, the access server causes the ticket (signed and encrypted or otherwise) to be communicated to the consumer access device, and particularly the access widget which produced the content access signal sent at process block 315 in FIG. 3B.

Back at the consumer access device from which the content access signal was received, the respective access widget may append the ticket as a parameter to the premium content link for which the content access signal was sent, and causes the consumer access device (perhaps through the browser executing at that device) to communicate an access request to content server storing the premium content corresponding to the premium content link. This ticket appending step and access request to the appropriate content server is shown at process block 325 in FIG. 3B.

As shown at process block 328 of FIG. 3C, the content server receiving the access request generates a redemption request which includes the ticket or encrypted ticket together with information that identifies the content for which the access is being requested, and causes that redemption request to be communicated to the access server (100 in FIG. 1). This redemption request is generated by content server redemption processing program code executed at the content server. This content server redemption processing program code provides the functionality of detecting an incoming access request for content which the publisher has designated as premium content in accordance with the present access control system, and responsive to such an access request, generating and causing the redemption request to be communicated to the access server.

The access server receives the redemption request as indicated at process block 329, and validates the ticket. The validation process may include decrypting the ticket if encrypted, validating the ticket's signature if signed, and looking up the corresponding ticket record in the access database and comparing the premium content identifying information included in the redemption request with the premium content identifying information in the ticket record to verify that the ticket included in the redemption request is associated with premium content corresponding to the premium content link. If the located ticket record does not correspond to the requested premium content or if the ticket is otherwise invalid as indicated by a negative outcome a decision block 332, the access server sends an error message to the content server and the content server responds by denying access to the premium content which was the subject of the access request received at process block 328. This error message and access denial step is shown at process block 334. However, if the located ticket record corresponds to the requested premium content, the access responds to the redemption request by changing the state of the access server according to the terms of access for the premium content as shown at process block 336 and sends an access approval signal to the content server. The terms of access employed to change the state of the access server may be determined form the ticket record in some forms of the invention. Where the conditions for access require a payment from the consumer/user, the change in state may include deducting the purchase amount contained in the ticket record from the consumer/user's account and crediting the publisher/user account corresponding to the content. The publisher/user account may be associated with the specific content gateway web page or the domain for that page. Ultimately, as shown at process block 338, the content server receives the access approval signal from the access server and sends the requested premium content to the consumer access device.

In some forms of the invention, if the ticket is not valid, the access server verifies that the indicated content is protected. If it is, the access server returns an error to the content server and the content server denies access to the content. If the indicate content is not protected, the access server sends an access approval signal to the content server and the content server sends the requested content to the consumer access device. This procedure performed when the ticket in the redemption request is not valid addresses the situation in which the content was protected through the access control system when the ticket was issued, but is no longer protected through the access control system.

FIG. 4 shows the various communications between the consumer access device, content gateway server/content server, and access server described in the FIG. 3A-C. It should be noted that for purposes of FIG. 4 it is assumed that the content gateway server, that is, the server which hosts the content gateway web page, is the same server that hosts the premium content. However, it should be appreciated that the content server hosting the premium content may be a different server that the server hosting the content gateway web page.

It should be noted that the overall process which in FIG. 3A and the corresponding communications shown in FIG. 4 are performed each time a respective consumer access device accesses a content gateway web page configured according to the present invention. An access server according to the present invention is therefore configured to execute numerous parallel or overlapping instances of this process. The same is true of the process steps shown in FIGS. 3B-C and the corresponding communications shown in FIG. 4. An access server is configured to perform many different instances of this process over a common or overlapping period of time.

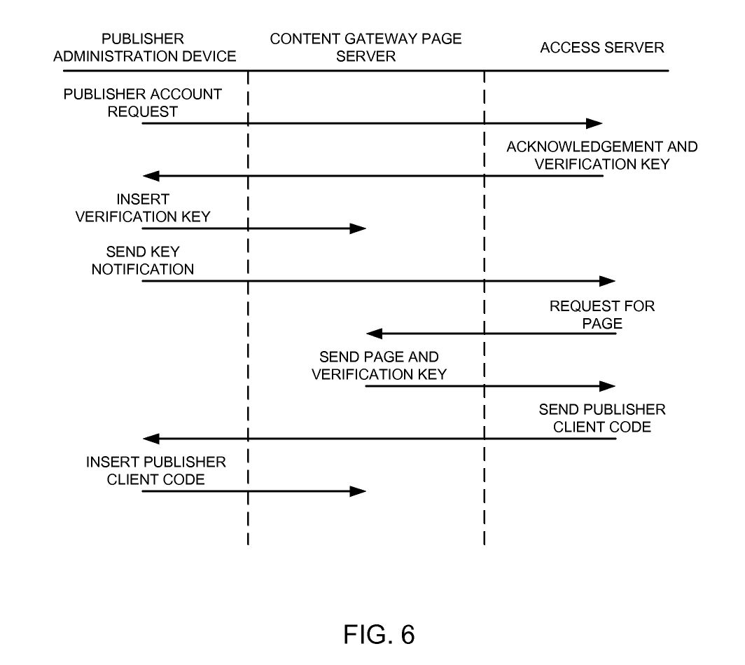

FIGS. 5A and 5B illustrated one preferred process for allowing a publisher to set up a content gateway web page for performing the process described in connection with FIGS. 3A-B. FIG. 5A illustrates a process performed to ensure that a publisher that requests to setup a given web page as a content gateway web page is the owner of that web page or is otherwise authorized to control the web page. The process shown in FIG. 5A includes sending a request for a publisher account as shown at process block 501 and receiving the request and opening/storing a publisher account as indicated at process block 502. These steps assume the publisher does not already have an account with the access server. As shown at process blocks 502 and 504 the access server sends a verification key to the publisher, either via download from an access server web page or via an email, or in some other suitable fashion. The publisher then places the verification key on the web page to be administered. The access server thereafter accesses the web page to be administered and looks for the verification key on the page as indicated at process block 506. If the key is not located the process branches from decision box 508 and the access server sends an appropriate error message to the publisher as shown at process block 510. Otherwise, the access server stores an association between the publisher account and the web page to be administered (or the domain for that page) as indicated at process block 512. Once the access server stores the association between the publisher account and the web page to be administered (or the domain for that page) the access server will allow the process described in FIG. 5B. FIG. 6 shows the various communications required in the process shown in FIG. 5A. Of course the publisher client code must be inserted in the web page to be administered and the content server must include the content server redemption processing program code to facilitate the process described in FIGS. 3A-C.

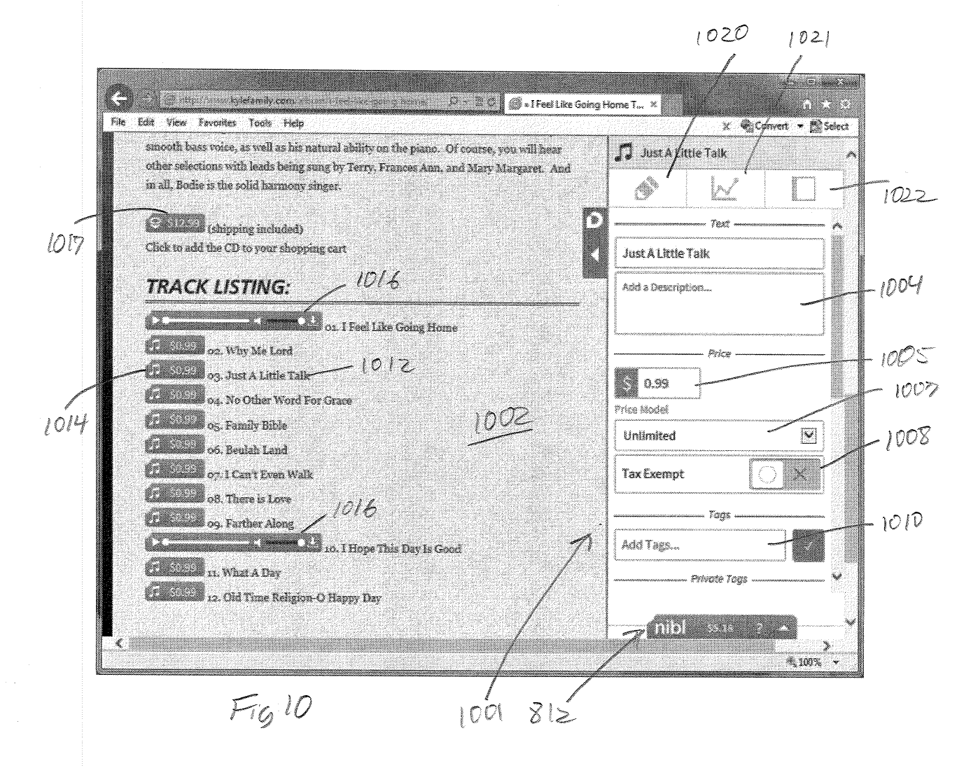

FIG. 5B illustrates a process by which a publisher who has proven authority to administer a given web page may configure that web page as a content gateway web page for purposes of the process described above in connection with FIGS. 3A-3C. In this example process of FIG. 5B, the publisher first logs into their publisher account maintained by the access server through a publisher administration device as shown at process block 520. The publisher administration device may be any access device executing a browser when the network through which the invention is implemented comprises the Internet. With the publisher logged in to their publisher account maintained by the access server, the publisher then controls the publisher administration device to send a request to the gateway page server for the web page to be administered as shown at process block 522. That is, the publisher directs the browser of the publisher administration device to the address for the web page to be administered. The gateway page server receives the page access request from the publisher administration device and responds by causing the web page to be administered and the publisher client code associated with that page to be communicated to the publisher administration device as shown at process block 524. The publisher administration device then displays the web page to be administered and executes the publisher client code as indicated at process block 526. Also, the publisher client code causes the publisher administration device to send an administration request to the access server. The access server receives the publisher page administration request as indicated at process block 528 and causes an administration widget to be communicated to the publisher administration device over the network. As shown a process block 529 the publisher administration device receives and executes the administration widget to display an administration interface with the web page to be administered. Once the administration interface is displayed on the web page to be administered, the publisher may make selections and enter information through the administration interface as indicated at process block 530. These selections and information relate to a link to be set up as a premium content link on the web page to be administered and cause the administration widget to send a link setup request to the access server over the network. The access server receives link setup request as indicated at process block 532 and uses the data included in the link setup request to generate and store an asset record associated with the respective premium content link. The asset record may include all of the conditions specified through the administration interface for access to the premium content corresponding to the premium content link. The access server then sends a setup acknowledgment to the publisher administration device. As shown a process block 534 the publisher administration device receives the link setup acknowledgment and modifies the web page to be administered accordingly. For example, the administration widget may respond to the link setup acknowledgment to modify the user interface so that it is apparent to the user/publisher that the desired premium content link has been set up with an access control. Example access controls will be described below in connection with the screen shot of FIG. 10.

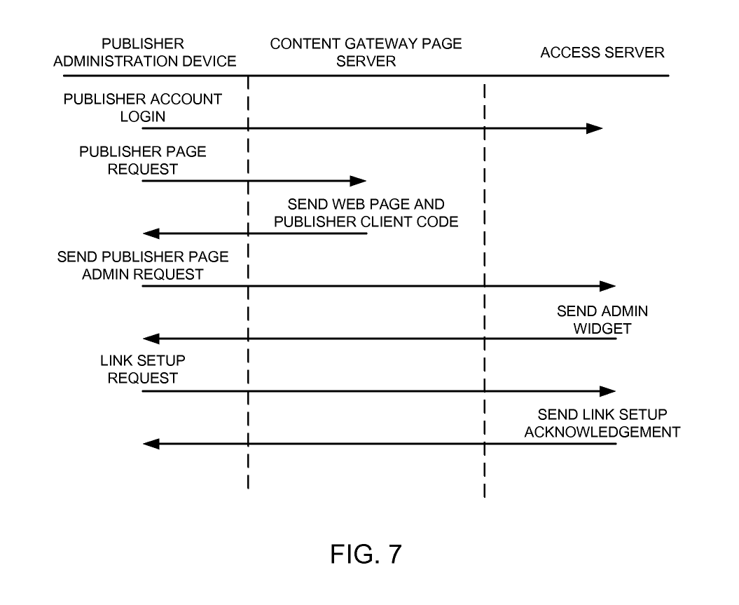

FIG. 7 shows the various communications between the publisher administration device, content gateway page server, and access server indicated in FIG. 5B. It will be appreciated that process steps shown in FIG. 5B refer to setting up a single web page as a content gateway web page according to the invention. Thus, numerous instances of this process may be conducted at any given time. The access server must therefore be configured to accommodate numerous concurrent instances of the process shown in FIG. 5B, as well as concurrent instances of the process shown in FIGS. 3A through 3C.

FIGS. 8-12 comprise screen shots showing various user interfaces which may be generated on a web page according to embodiments of the present invention. FIG. 8 shows a consumer/user control panel 801 appearing on a web page 802 displayed through a browser executing at a consumer access device such as device 108 in FIG. 1. Consumer/user control panel 801 shown in FIG. 8 includes an identifier 804 associated with the consumer/user account, an account balance 805, a control 806 for adding further credit to the balance, a control 808 for accessing further account information, and a control 809 for allowing the consumer/user to sign out of their account with the access server.

In some forms of the invention, consumer/user control panel 801 is generated by a consumer/user control panel widget which is executed on the particular web page. In these forms of the invention when a consumer/user is logged in to their access server account and navigates their access device (such as a PC executing an Internet browser) to a domain that is associated with a publisher/user account, the publisher client code executed at the access device when the publisher web page is displayed sends a control panel request to the access server. This control panel request is able to identify the consumer/user since the user is logged in to their access server account. Thus the access server may cause the consumer/user control panel widget to be communicated to the access device displaying the web page together with information to populate the consumer/user-dependent fields in the consumer/user control panel.

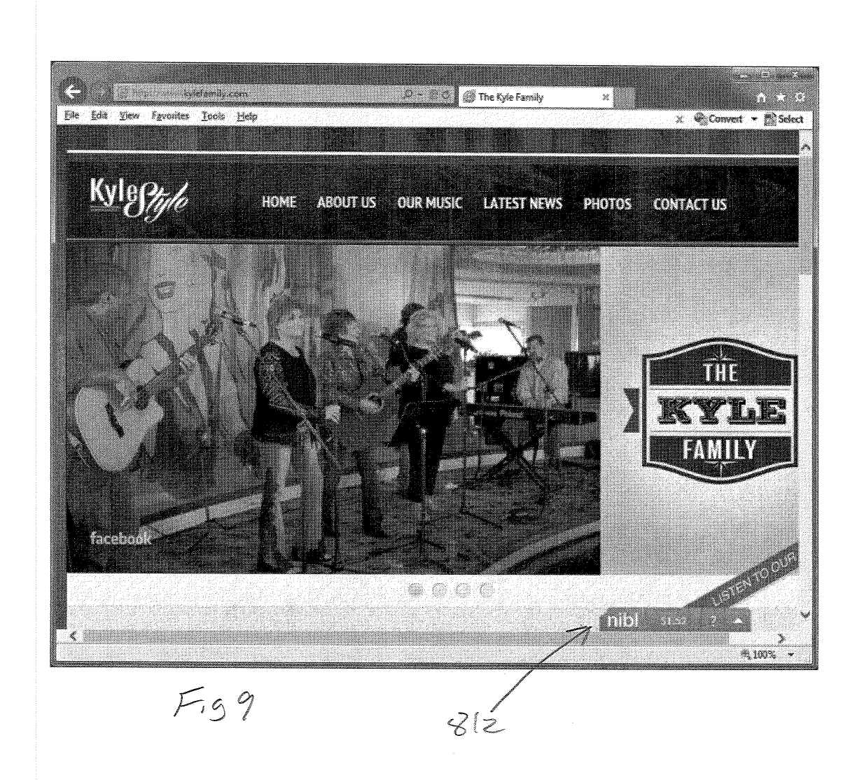

In the embodiment shown in FIG. 8, consumer/user control panel 801 also includes a minimal panel section 812 that includes the account balance 814, a help control 815, and a collapse/expand control 816 which may be invoked to limit the control panel to just the minimal panel section. FIG. 9 shows the consumer/user control panel in a collapsed state showing just the minimal panel section 812.

It should be noted that in the case of both FIG. 8 and FIG. 9, neither web page comprises a content gateway web page. That is, neither of these web pages includes any consumer interface that would be produced by an access widget as discussed above in connection with FIG. 3A. The consumer/user control panel 801 in the examples in FIGS. 8 and 9 are displayed because even though the respective web page does not include any consumer interface to premium content, each web page is under a domain that is associated with a publisher/user account. In alternative forms of the invention, a consumer/user control panel such as panel 801 or minimal panel section 812 may be displayed on a web page only if that particular web page comprises a content gateway web page and thus includes at least one consumer interface produced under control of an access widget as described above in connection with FIG. 3A.

FIG. 10 shows an administration interface 1001 displayed in under control of an administration widget executing within the web page 1002 in the process described above in connection with FIG. 5B. Administration interface 1001 in this example is shown in an expanded condition with a number of administration controls. This particular example includes a text insert control 1004, a price input/selection control 1005, a price model control 1007, a tax exemption status control 1008, and a tag addition control 1010. Mode controls at the top of administration interface include an edit mode control 1020, an analytics mode control 1021, and an docking control 1022. Text insert control 1004 allows the publisher/user to input descriptive text for a given consumer interface on the web page. Price input/selection control 1005 allows the publisher user to select or input a price for content associated with a given premium content link, while price model control 1007 provides a menu for selecting a price model defining the term access for the indicated price. Edit mode control 1020 may be invoked to place the administration interface in an edit mode. This is the mode shown in FIG. 10. In the edit mode, the publisher/user changes the focus of the administration interface to a give link on web page 1002 by selecting that link with a pointer control of the computer or other device serving as the publisher administration device. The focus of the interface 1001 as shown in FIG. 10 is on the link entitled “Just A Little Talk.” Analytics mode control 1021 may be invoked by the publisher/user to place the administration interface in an analytics mode to show analytics information regarding the various premium content links on page 1002. Docking control 1022 may be invoked to undock the administration interface 1001 from the left side of web page 1002, and allows the interface to be moved to other positions on the web page.

The state of administration interface 1001 shown in FIG. 10 coincides with a user selection of the premium content link 1012 identified by the title “Just A Little Talk” appearing on the content gateway web page 1002. This premium content link is associated in the web page with a tag 1014. Tag 1014 displays the price associated with premium content link 1012 which was previously added using the tag addition control 1010. This tag 1014 and the other similar tags shown on example page 1002 represent a consumer interface that, after setup of the web page as a content gateway web page, will be displayed as under control of an access widget executed with the page as described above in connection with FIG. 3A. In this example implementation, the consumer interface for a given premium content link is positioned adjacent to that link and provides an indication of the price together with an indication of the type of content. In this case the musical note symbol in tag 1014 indicates that the premium content is audio content. Tags for other types of content may include different symbols or indicators to indicate the particular type of content and/or the type of access granted for the displayed price. This example shows a different type of consumer interface 1016 associated with tracks 1 and 10 in the track listing. These consumer interfaces may be invoked to play the associated premium content or download the premium content free of charge. The example shown in FIG. 10 also shows a physical product consumer interface 1017 that may be invoked to purchase a physical product, in this case a CD containing all of the tracks listed in the track listing. When a consumer/user selects this physical product consumer interface 1017, information regarding the product is saved in a shopping cart maintained by the access server for the content publisher.

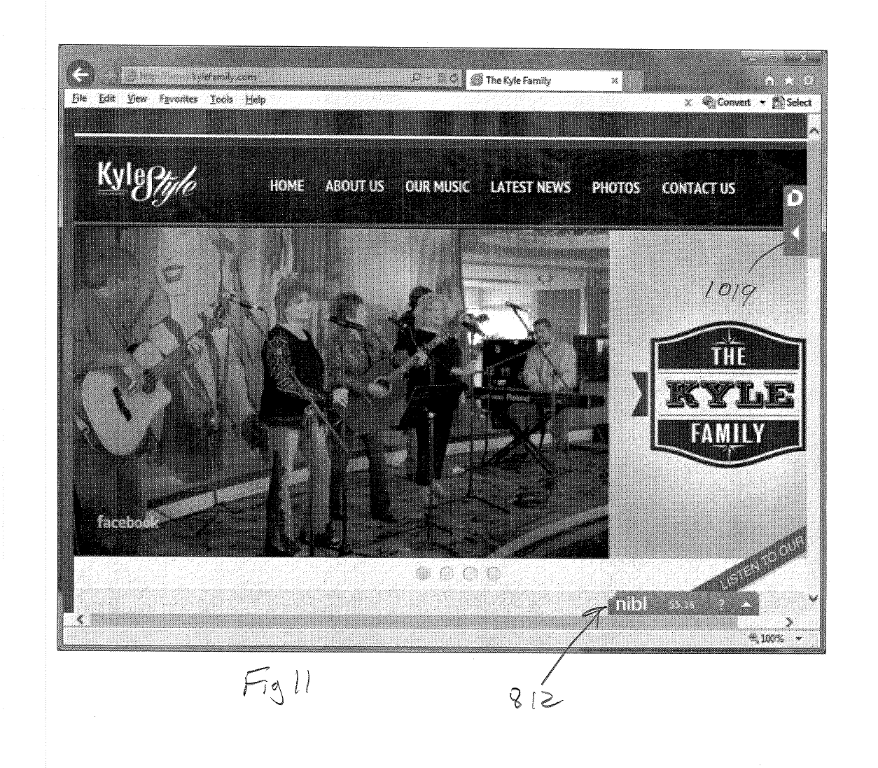

The example shown in FIG. 11 simply shows the administration interface in a collapsed state showing only the expand collapse control 1019 and also showing the consumer/user control panel 812 in its collapsed state. It will be noted again that this example webpage includes no premium content links and thus shows no consumer interface controls (such as tag 1014 shown in FIG. 10) for obtaining controlled access to any premium content.

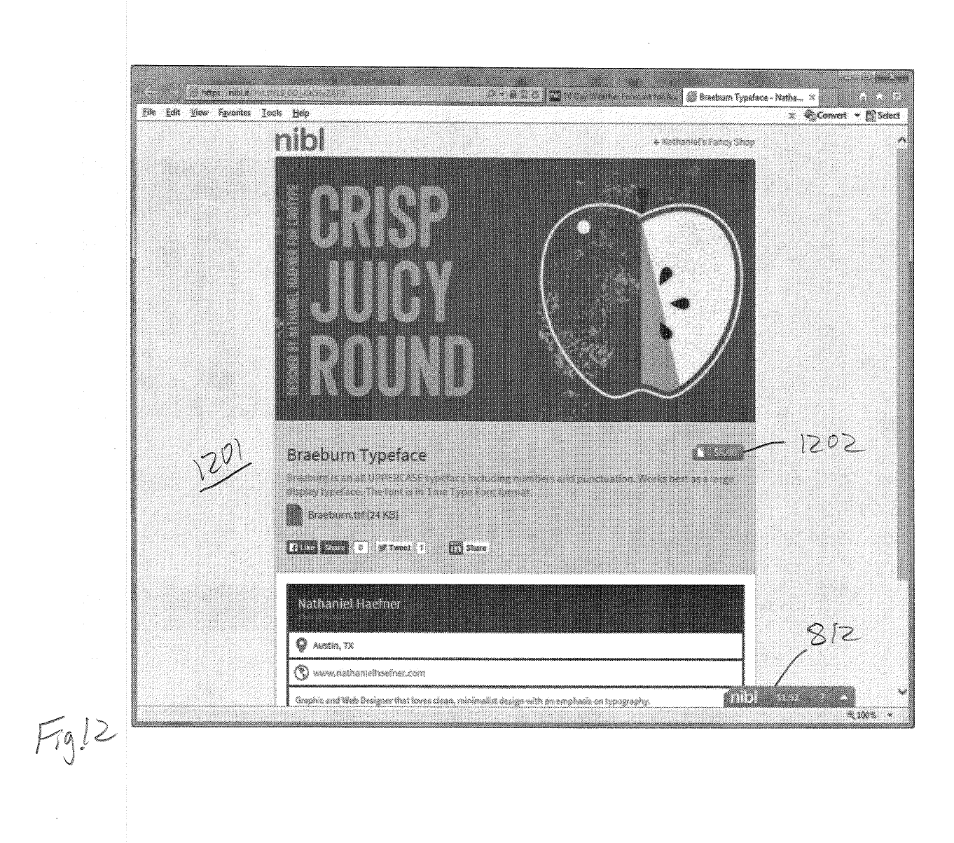

FIG. 12 shows an example of an access server-hosted website 1201 including a consumer interface 1202 produced under the control of an access widget according to the invention and also including a collapsed consumer/user control panel 812. In this example, the content gateway webpage is hosted internally to the access server rather than through a remote content server.

In another aspect of the present invention the access server employs a specialized widget in place of the access widget described above in connection with FIG. 3A to support actions which are not necessarily associated with a product purchase. An action widget in accordance with this aspect of the present invention is executable at the consumer access device to cause the generation of an action interface on the web page. If a consumer/user selects an action via an action interface, the action widget contacts the access server and sends the descriptor for the implicated premium content link along with information about the consumer/user. The access server processes the request by first validating the consumer/user. If the consumer/user is not valid, the access server returns an error, and the action widget generates a user interface that requests that the consumer/user log in. If the consumer/user is valid, the access server validates the descriptor. If the descriptor is valid, the access server validates that the consumer/user has sufficient funds to purchase the premium content if a purchase is required. If a purchase is required and the consumer user does not have sufficient funds, the access server returns and error and the action widget generates a user interface at the web page that requests that the consumer/user add funds to their access server account.

If all necessary conditions are met (there may be other conditions), the access server creates a ticket record. The ticket record contains information specific to the request, including a subset of information in the descriptor, information about the consumer/user, an expiration date, and a unique ticket identifier. The access server stores the ticket record in the access database. The ticket record specifies a price of zero. The access server then generates a ticket for the ticket record using the unique identifier of the ticket record. Is some cases, the ticket may be signed and encrypted.

The access server then sends a request to the website at the address specified in the descriptor and using the ticket. The request may contain action specific information specified by the website.

If a website receives a request for an action that contains a ticket, the website contacts the access server and attempts to redeem the ticket by sending a redemption request to the access server. Responsive to the redemption request, the access server will decrypt the ticket, if encrypted, and validate the ticket signature if signed, look up the corresponding ticket record, and if the ticket record corresponds to the requested action identified in the redemption request, the access server returns a positive response to the website, which can perform server side data modification. The website then returns a successful response to the access server.

If the access server receives a successful response from the website, the access server deducts the price of the action if any from the consumer/user account and credits the domain of the action. It then returns a successful response to the action widget. Upon receiving a successful response, the action widget calls client code that notifies the web page that the action was successfully executed. The notification includes information that allows the client to match up information with information sent by the access server to the website.

In another aspect of the invention a publisher/user may specify a graph based price for their premium content. This graph based price varies the price of the premium content based on how many degrees of separation the purchaser (consumer/user) is from the seller (publisher/user) on a graph. In this sense, a graph is a mathematical construct that models relationships between entities. An entity is a node, and a relationship is a link. For example, in the social graph used by Facebook®, users are nodes, and if they are friends, users are related, or linked. For any two nodes, the graph distance may be calculated. The graph distance is the minimum number of links that must be traversed to go from one node to another. There are other graph properties that relate one node to another.

The present invention employs the value of a selected graph property function that takes as a parameter two nodes that represent the seller (publisher/user) and buyer (consumer/user) as a parameter when computing the price of a good or service. In a social graph for example, if a seller is selling a good, their friends may receive it for free, while friends of friends pay a small prices, and anyone farther in the graph pays full price.

This graph based pricing may be implemented in embodiments of the access control system according to the invention by providing the publisher/user at least one graph-based pricing option in the pricing options available through the administration interface such as that shown for example in FIG. 10. When the publisher/user selects a graph-based pricing option, the selections determines certain additional steps which must be taken to determine if all conditions are met for granting access to the requested premium content. These steps include calling an appropriate graph distance calculating process which uses a graph (the Facebook® graph or any other appropriate graph) together with information on the publisher/user and consumer/user, to calculate the graph distance between the publisher/user and the consumer/user. The price determined for access to the premium content is then based at least in part upon the calculated graph distance. For example, graph distances within a predetermined number of links may be defined as requiring a first access price, while graph distances within a higher predetermined range of links may be defined as requiring a higher price. Graph distances within a yet higher range of links may be defined as requiring a yet higher price for access to the premium content.

The above processes described above refer to different user log in steps, for example, by a consumer user of the access control system or by a publisher user of the access control system. These login steps may include any suitable login arrangement. For example, a user may navigate to a login web page hosted by the access server and providing a place to enter a user name and password associated with a previously created account for the user. When the enters their user name and password and operates the page controls to send that data to the access server, the access server may update the status of the user in a user database and may return a login cookie to the user's access device from which they entered the username and password. Thereafter, any communication from that user access device may include the login cookie to allow the access server to recognize that the communication is associated with the particular user.

As used herein, whether in the above description or the following claims, the terms “comprising,” “including,” “carrying,” “having,” “containing,” “involving,” and the like are to be understood to be open-ended, that is, to mean including but not limited to. Similarly, the term “each” is not intended to be read as exclusive. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above described preferred embodiments are intended to illustrate the principles of the invention, but not to limit the scope of the invention. Various other embodiments and modifications to these preferred embodiments may be made by those skilled in the art without departing from the scope of the present invention. For example, the above disclosure refers to many communications and signals sent from and to the access server. These communications may be in any form supported by the computer network and may be single signals of communications or divided up into multiple distinct signals or communications to transfer the desired information.

1. A method for facilitating access control for online content, the method including:
(a) receiving a publisher page administration request at the access server, the publisher page administration request being received from a publisher administration device, the publisher page administration request identifying a web page to be administered;
(b) responsive to the receipt of the publisher page administration request and under control of the access server, causing an administration widget to be communicated to the publisher administration device, the administration widget being executable at the publisher administration device to display an administration interface on the web page to be administered;
(c) receiving a first link setup request at the access server, the first link setup request being communicated from the publisher administration device under control of the administration widget and identifying a first premium content link included on the web page to be administered, the first link setup request also including data specifying publisher-selected conditions for access to first premium content through the first premium content link; and
(d) responsive to the first link setup request, generating and storing a first asset record at an asset record database accessible to the access server, the first asset record including the data specifying publisher-selected conditions for access to the first premium content through the first premium content link.

2. The method of claim 1 further including:
(a) receiving a second link setup request at the access server, the second link setup request being communicated from the publisher administration device under control of the administration widget and identifying a second premium content link included on the web page to be administered, the second link setup request also including data specifying publisher-selected conditions for access to second premium content through the second premium content link; and
(b) responsive to the second link setup request, generating and storing a second asset record at the access record database, the second asset record including the data specifying publisher-selected conditions for access to the second premium content through the second premium content link.

3. The method of claim 1 further including, prior to receiving the publisher page administration request:
(a) receiving a publisher page setup request at the access server; and
(b) under control of the access server, causing publisher client code to be communicated to a publisher for installation in the web page to be administered.

4. The method of claim 3 further including, after receiving the publisher page setup request and under control of the access server, associating a publisher user account with the web page to be administered.

5. The method of claim 1 wherein the data specifying publisher-selected conditions for access to the first premium content through the first premium content link includes a price for access to the first premium content through the first premium content link.

6. The method of claim 1 wherein the data specifying publisher-selected conditions for access to the first premium content through the first premium content link includes an access type identifier for access to the first premium content through the first premium content link, the access type identifier comprising one of an unlimited access identifier and a limited access identifier.

7. The method of claim 6 wherein the limited access identifier specifies a time for access to the first premium content through the first premium content link.

8. The method of claim 1 wherein the data specifying publisher-selected conditions for access to the first premium content through the first premium content link includes a first access type identifier for access to the first premium content through the first premium content link, the first access type identifier comprising one of an unlimited access identifier and a limited access identifier and wherein the data specifying publisher-selected conditions for access to the second premium content through the second premium content link includes a second access type identifier for access to the second premium content through the second premium content link, the second access type identifier comprising one of the unlimited access identifier and the limited access identifier.

9. The method of claim 8 wherein the first access type identifier comprises one of the unlimited access identifier and the limited access identifier and the second access type identifier comprises the other one of the unlimited access identifier and the limited access identifier.

10. The method of claim 8 wherein the first access type identifier comprises the limited access identifier associated with a first access time limitation and the second access type identifier comprises the limited access identifier associated with a second access time limitation different from the first access time limitation.

11. The method of claim 1 wherein the administration widget is executable at the publisher administration device to display a number of different premium content access types, each respective premium content access type being associated with a different set of access limitations.

12. An access server for configuring a web page to facilitate access control to online content, the access server including:
(a) a network controller operatively connected to a computer network;
(b) one or more processors operatively connected for communications to and from the computer network through the network controller; and
(c) one or more program storage devices storing program code executable to:
(i) receive a publisher page administration request, the publisher page administration request being received from a publisher administration device and identifying a web page to be administered;
(ii) responsive to the receipt of the publisher page administration request, cause an administration widget to be communicated to the publisher administration device, the administration widget being executable at the publisher administration device to display an administration interface on the web page to be administered;
(iii) receive a first link setup request, the first link setup request being communicated from the publisher administration device under control of the administration widget and identifying a first premium content link included on the web page to be administered, the first link setup request also including data specifying publisher-selected conditions for access to first premium content through the first premium content link; and
(iv) responsive to the first link setup request, generate and store a first asset record in an asset record database accessible to the access server, the first asset record including the data specifying publisher-selected conditions for access to the first premium content through the first premium content link.

13. The access server of claim 12 wherein the one or more program storage devices also store program code executable to:
(a) receive a second link setup request, the second link setup request being communicated from the publisher administration device under control of the administration widget and identifying a second premium content link included on the web page to be administered, the second link setup request also including data specifying publisher-selected conditions for access to second premium content through the second premium content link; and
(b) responsive to the second link setup request, generate and store a second asset record at the asset record database, the second asset record including the data specifying publisher-selected conditions for access to the second premium content through the second premium content link.

14. The access server of claim 12 wherein the one or more program storage devices also store program code executable to, prior to receipt of the publisher page administration request:
(a) receive a publisher page setup request; and
(b) cause publisher client code to be communicated to a publisher for installation in the web page to be administered.

15. The access server of claim 12 wherein the data specifying publisher-selected conditions for access to the first premium content through the first premium content link includes a price for access to the first premium content through the first premium content link.

16. The access server of claim 12 wherein the data specifying publisher-selected conditions for access to the first premium content through the first premium content link includes an access type identifier for access to the first premium content through the first premium content link, the access type identifier comprising one of an unlimited access identifier and a limited access identifier, wherein the limited access identifier specifies a time for access to the first premium content through the first premium content link.

17. The access server of claim 12 wherein the administration widget is executable at the publisher administration device to display a number of different premium content access types, each respective premium content access type being associated with a different set of access limitations.

18. A program product comprising one or more non-transitory computer readable media storing program code, the program code including:
(a) publisher page administration program code executable at an access server to (i) receive a publisher page administration request from a publisher administration device, the publisher page administration request identifying a web page to be administered, and to (ii) responsive to the receipt of the publisher page administration request, cause an administration widget to be communicated to the publisher administration device, the administration widget being executable at the publisher administration device to display an administration interface on the web page to be administered; and
(b) publisher link setup program code executable at the access server to (i) receive a first link setup request, the first link setup request being communicated from the publisher administration device under control of the administration widget and identifying a first premium content link included on the web page to be administered, the first link setup request also including data specifying publisher-selected conditions for access to first premium content through the first premium content link, and to (ii) responsive to the first link setup request, generate and store a first asset record in an asset record database accessible by the access server, the first asset record including the data specifying publisher-selected conditions for access to the first premium content through the first premium content link.

19. The program product of claim 18 wherein the publisher link setup program code is also executable at the access server to (i) receive a second link setup request, the second link setup request being communicated from the publisher administration device under control of the administration widget and identifying a second premium content link included on the web page to be administered, the second link setup request also including data specifying publisher-selected conditions for access to second premium content through the second premium content link, and to (ii) responsive to the second link setup request, generate and store a second asset record at the asset record database, the second asset record including the data specifying publisher-selected conditions for access to the second premium content through the second premium content link.

20. The program product of claim 18 further including publisher page setup processing program code executable at the access server to, prior to receiving the publisher page administration request, receive a publisher page setup request at the access server, and cause publisher client code to be communicated to a publisher for installation in the web page to be administered.
